(19) United States
(12) Patent Application Publication
(10) Pub. No.: US 2009/0204438 A1
(43) Pub. Date: Aug. 13, 2009

(54) Client Encounter Electronic Data Research Record Systems and Methods

(76) Inventor: George M. PYLE, San Antonio, TX (US)

Correspondence Address: KAMMER BROWNING PLLC, 7700 BROADWAY, SUITE 202, SAN ANTONIO, TX, 78209, US

(21) Appl. No.: 12/369,730

(22) Filed: Feb. 11, 2009

Related U.S. Application Data
(60) Provisional application No. 61/027,488, filed on Feb. 11, 2008.

(51) Int. Cl. G06Q 50/00; G06F 3/048

(52) U.S. Cl. 705/3; 715/764

(57) ABSTRACT

A client encounter electronic research record system, method, and computer product includes pre-populated, research specific templates, selective, specialty-specific master databases, qualitative and quantitative specific databases and templates to achieve comprehensive, accurate and compliant research/efficacy documentation that captures client data concurrently with the client encounter session. The system is enabled for web distributed computing environment including graphical user interfaces, and text, digital image and tablet computer input.

### CROSS REFERENCE TO RELATED APPLICATIONS

This application claims the benefit under Title 35 United States Code § 119(e) of U.S. Provisional Application No. 61/027,488; Filed: Feb. 11, 2008, the full disclosure of which is incorporated herein by reference.

### BACKGROUND OF THE INVENTION

1. Field of the Invention

The present invention relates generally to systems and methods for clinical information capture and analysis for efficacy. The present invention relates specifically to systems and processes by which electronic clinical records may be created and modified in the clinical environment of real time data collection.

2. Description of the Related Art

Efficacious data collection for individual client sessions is needed in the medical, educational, psychological, and research fields. The collection of this data is often inconsistent, inaccurate and difficult to collate and analyze. According to one's need for environment and purpose, data is collected in numerous formats of quantitative and qualitative measurements. There is currently no method of electronic research record system available to capture this data. This invention solves these problems by defining systems and methods that provide:

User friendly graphical user interface (G.U.I.) software to instantaneously collect qualitative and quantitative client based data.

World Wide Web access to program and client file storage with PDA-pc mobile compatibility.

Single Subject Design research method built into program for efficacy documentation, data mining and best practice applications.

Therapists, researchers, and educators need an application/device for simple, easy, and reliable user based data collection that interfaces with their current reports, files and software systems. This will be first accomplished by:

Create simple G.U.I. that is designed for users needs.

Create website software for use on computer and/or computer based mobile devices.

Development of a simple calculator device that is inexpensive, and compatible with customers computer area network and/or blue tooth connectivity.

Touch-button interface.

Easy to learn, simple program.

Data instantly recorded in customer centered format and stored in database application.

Simple data import/export for other applications and systems.

### SUMMARY OF THE INVENTION

The present inventor has recognized that an improved data collection electronic records system includes the following characteristics: instantaneous data collection, it saves the clinician time, it has a minimum learning curve, it uses specialty specific databases, it uses a simple data “G.U.I.” that allows end user modifiable quantitative and qualitative data capture, addresses all portions of the “S.O.A.P” encounter model; (the S.O.A.P. note is short for Subjective, Objective, Assessment, and Plan. It is a short method employed by health care providers to document a patient encounter) the documentation produced integrates patient demographics, clinical information, efficacy analysis, reports and HCFA compliance requirements. Selected features of this system that achieves advantages over existing electronic client record systems include:

Clinician centered data collection based upon the S.O.A.P encounter model.

Data collection is separated from the S.O.A.P. and simplified by a novel data Graphic User Interface that allows for instantaneous quantitative and qualitative data collection.

Research Intervention Plan page that builds and pre-fills the S.O.A.P. note for clinician use.

Research Intervention Plan form automatically allows for multiple entities such as Demographic, Goal, Objective, and Variables to be measured by specialty specific “Research Library” databases for Efficacy analysis and reports.

New format for data G.U.I. allows for data collection for individual objectives by types of: Tally %, Range %, Scaled Score-default, Custom Scaled Score, Custom Tally % Scaled Score, Not Tested/No Response, Import of Image for Notation, Narrative Data.

Spontaneous “non-planned” data collection is allowed by “Clinical Observation” form based upon the S.O.A.P. format.

The present invention will improve productivity since the documentation process can be completed concurrently with the patient/client encounter.

The present invention will improve record keeping and retrieval for clinicians.

The present invention will improve client outcomes by allowing efficacy based interventions and research.

### BRIEF DESCRIPTION OF THE DRAWINGS

A more complete appreciation of the invention and the many attendant advantages thereof will be readily obtained as the same becomes better understood by reference to the following detailed description when considered in connection with the accompanying drawings wherein:

FIG. 1 is a schematic diagram for information flow for “WEB SITE SCREENS” that collect and manipulate data in the present invention.

FIG. 2 is schematic diagram showing the interrelationship between the various data sets and the functionality of the methodology of the present invention, as implemented in a computing environment.

FIG. 3 is a typical screen shot of an implementation of a “CUSTOMIZED S.O.A.P.” page and report graphical user interface for the system of the present invention.

FIG. 4 is a typical screen shot of an implementation of a “RESEARCH INTERVENTION PLAN” page graphical user interface for the system of the present invention.

FIG. 5 is a typical screen shot of an implementation of a “FLUX DATA PAD” data page graphical user interface for the system of the present invention.

FIGS. 6A-6F are screen shots of the various selectable pages illustrating the examples of the G.U.I. changes when choosing different buttons for different formats of quantitative and qualitative data from the screen shown in FIG. 5.

FIG. 7 is a schematic diagram for information flow for “FLUX DATA PAD” that collects and manipulates quantitative and qualitative data in the method of the present invention.

FIG. 8 is a schematic diagram for information flow for “RESEARCH INTERVENTION PLAN” that collects and manipulates data in the method of the present invention.

### DETAILED DESCRIPTION OF THE PREFERRED EMBODIMENTS

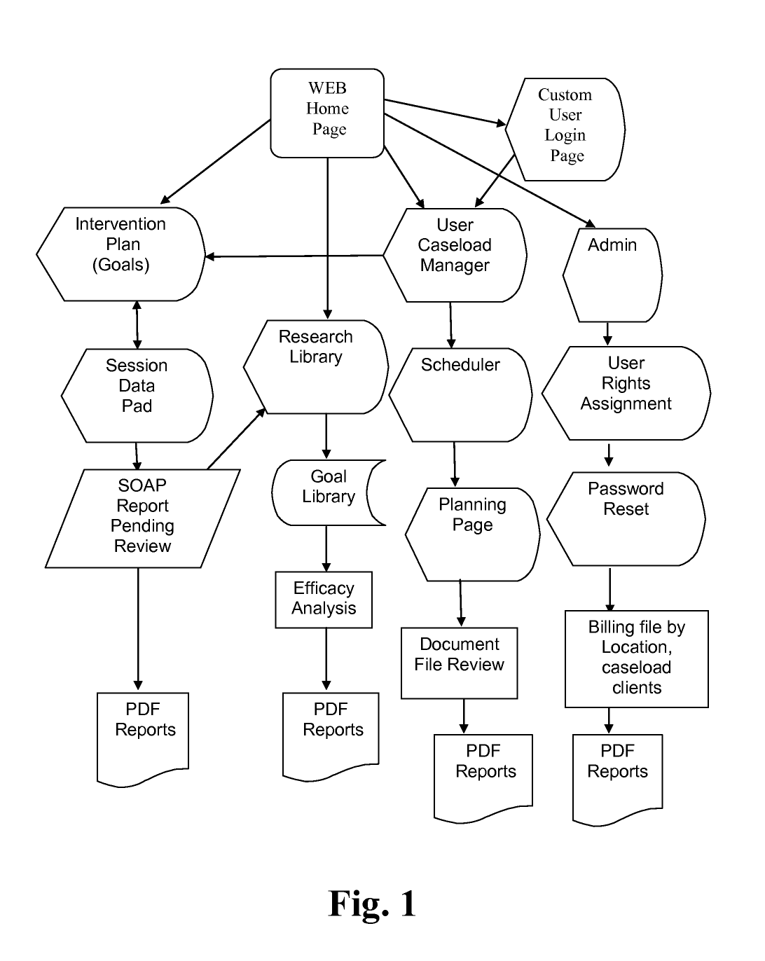

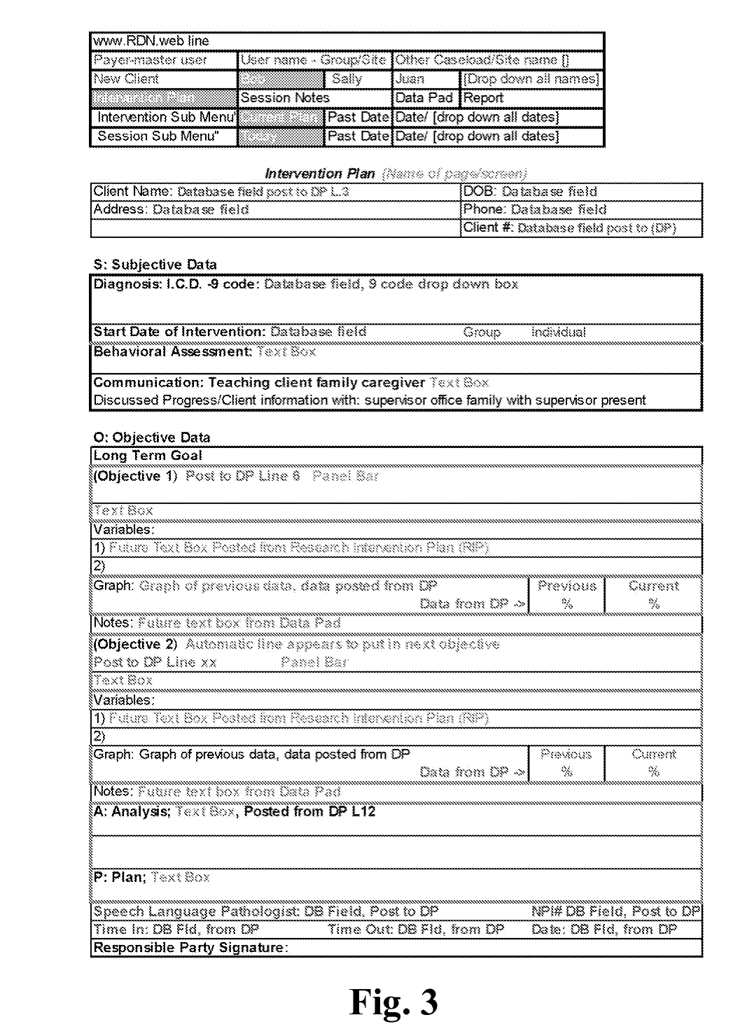

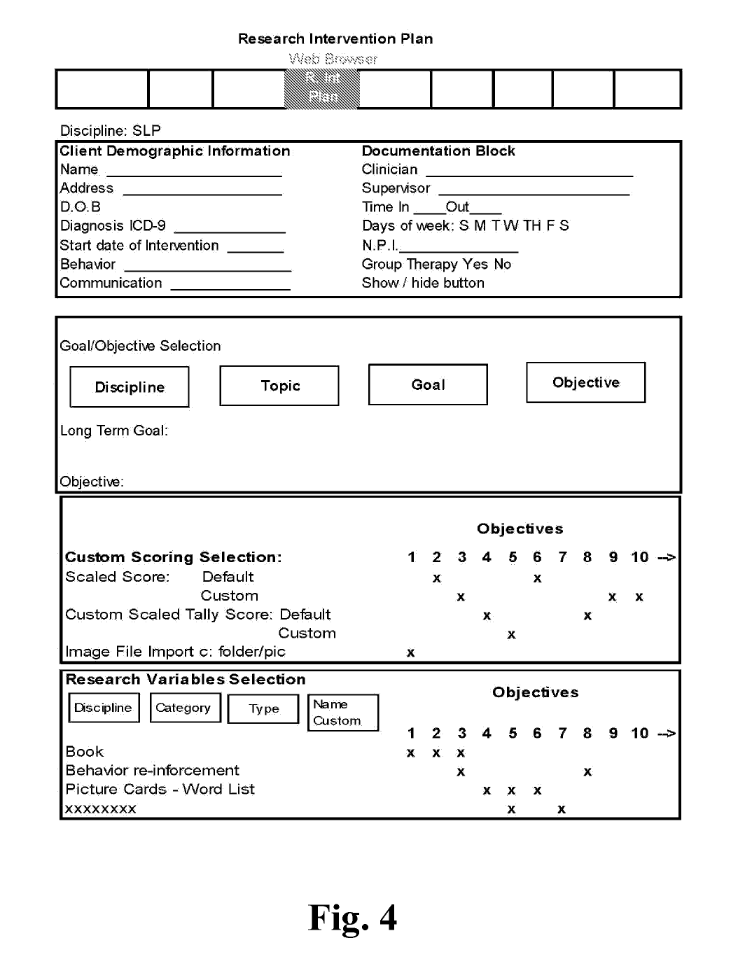

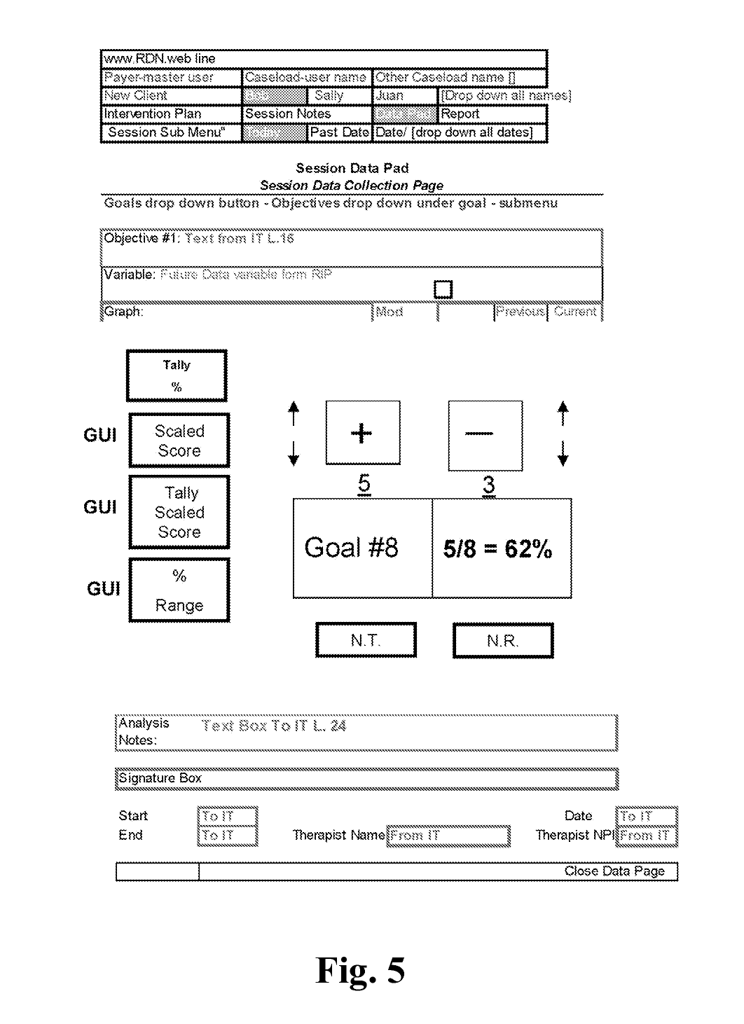

Referring to the drawings the flow chart (FIG. 1) is s system block diagram of a preferred embodiment according to the present invention. This system is based upon the S.O.A.P. encounter model represented by (FIG. 3). So much data is needed to correctly complete the S.O.A.P. that the populations of the forms for research planning (FIG. 4) and the data collection (FIGS. 5 & 6A-6F) as broken down into multiple pages. This novel approach allows for all separate pages to fill and populate the S.O.A.P. note while simplifying the use of each page by actual function.

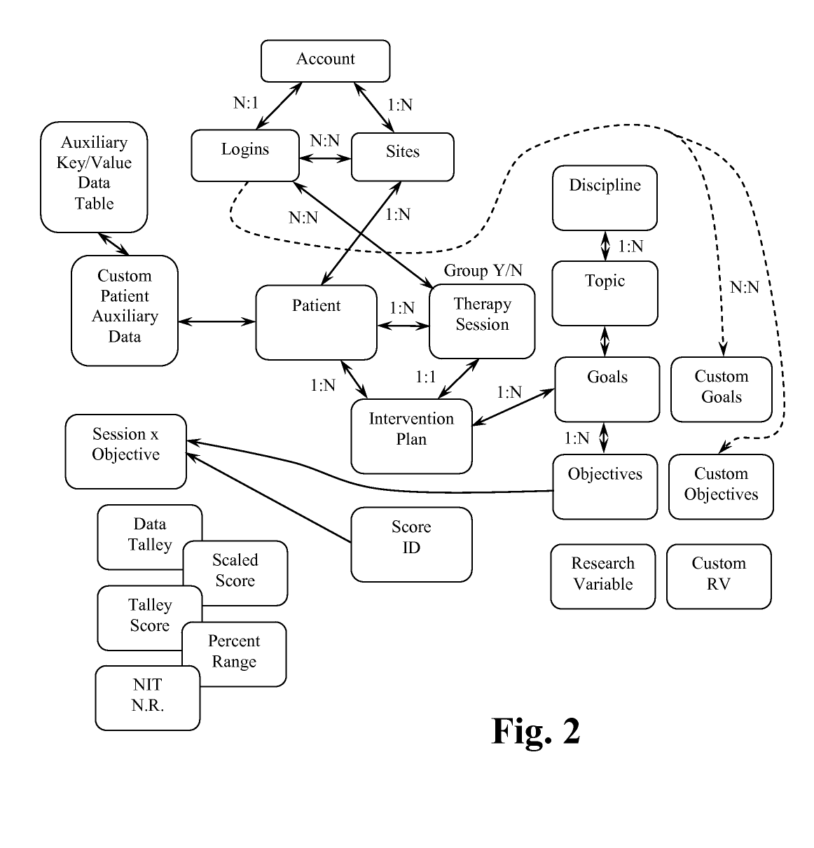

FIG. 2 is an administrative screen path diagram showing the manner in which the methodology of the present invention is implemented in a computer processing environment.

The first key component to collecting efficacious data during a client encounter is to have an intervention plan. This program is unique in that it includes research design within the plan for data collection. Thus this program gives the intervention plan the name—“Research Intervention Plan” to distinguish it from other plans. (FIG. 4) creates the Research Intervention Plan and pre-populates the demographics to the S.O.A.P. note. This page has four unique elements needed for a research based intervention plan not used together by other methods or programs. The four items unique to the Research Intervention Plan page are:
1) “Demographics and Field Selection Choices”
2) “Goal/Objective Selection”
3) “Pre-Selection of Custom Scoring G.U.I.” and
4) “Pre-selection and continual updating of the Research Variables”.

“Demographics and Field Selection Choices” allows the clinician to customize the format and pre-populate the S.O.A.P. Different clinicians have different needs in different settings. This function allows them to customize to their personal, company, and setting's needs.

“The Goal/Objective Selection” allows for choosing between pre-filled lists or typing a custom goal/objective. Custom goals and objectives entered by the clinician will be added to that customers default choices of goals and objectives the next time the system is accessed. This allows for speedy entry of the goals and objectives for the individual client's plan.

The “Pre-Selection of Custom Scoring G.U.I.” allows for choosing custom scaled score, custom scaled tally score, and image import. This option allows infinite choices to the clinician to pre-select the manner he or she wants to collect data. This format of data collection can be completely changed, adjusted or added to as the client intervention progresses.

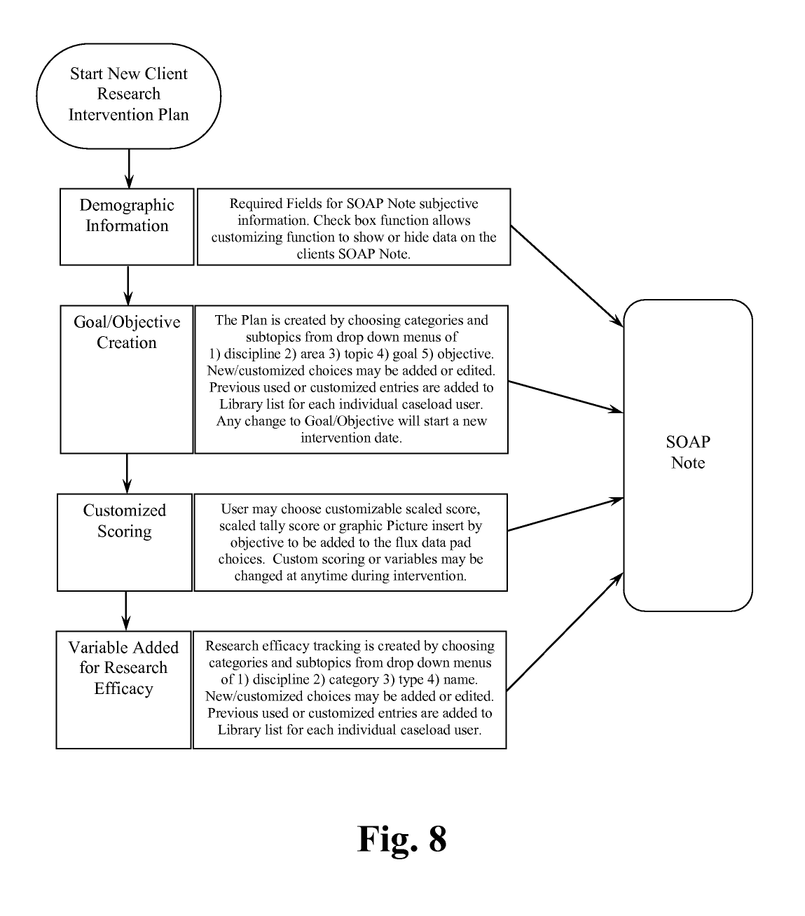

The “Pre-selection of the Research Variables” allows for customized selection and input of novel variables to be measure for single subject research design. This function is “key” to being able to track efficacy during real time, everyday client interventions. The clinician can make the Research Intervention Plan (FIGS. 4 & 8) as simple or as complicated as he or she desires, but all elements are present for tracking research efficacy. (FIG. 8) identifies the flow and setup of information sent to the S.O.A.P. This separation of information allows for the page/G.U.I function to build 1) the S.O.A.P. note and 2) research design for efficacy at the same time.

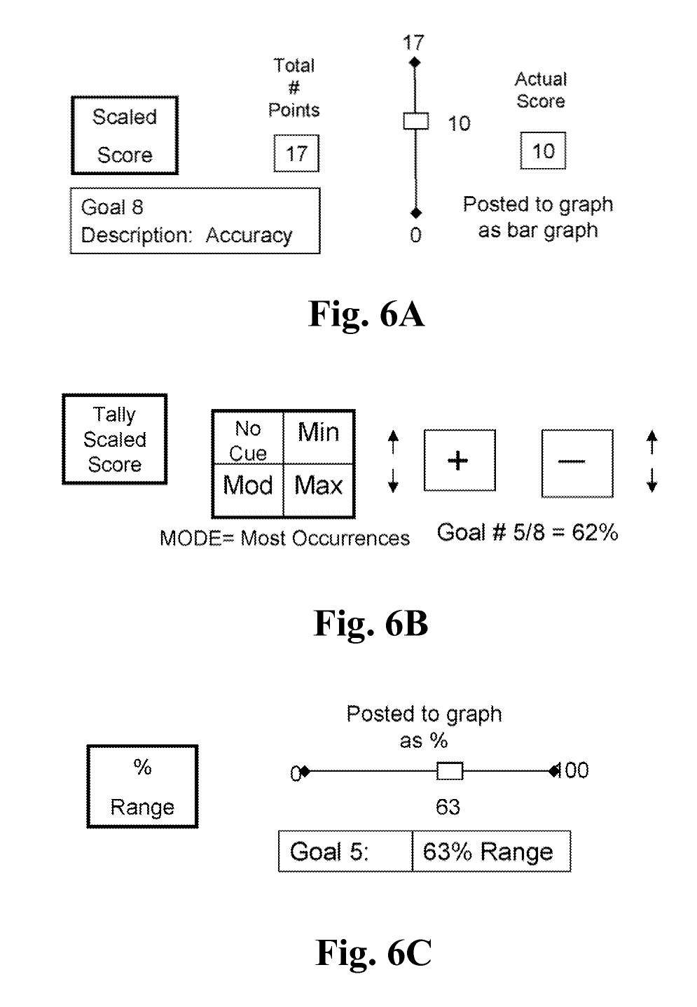

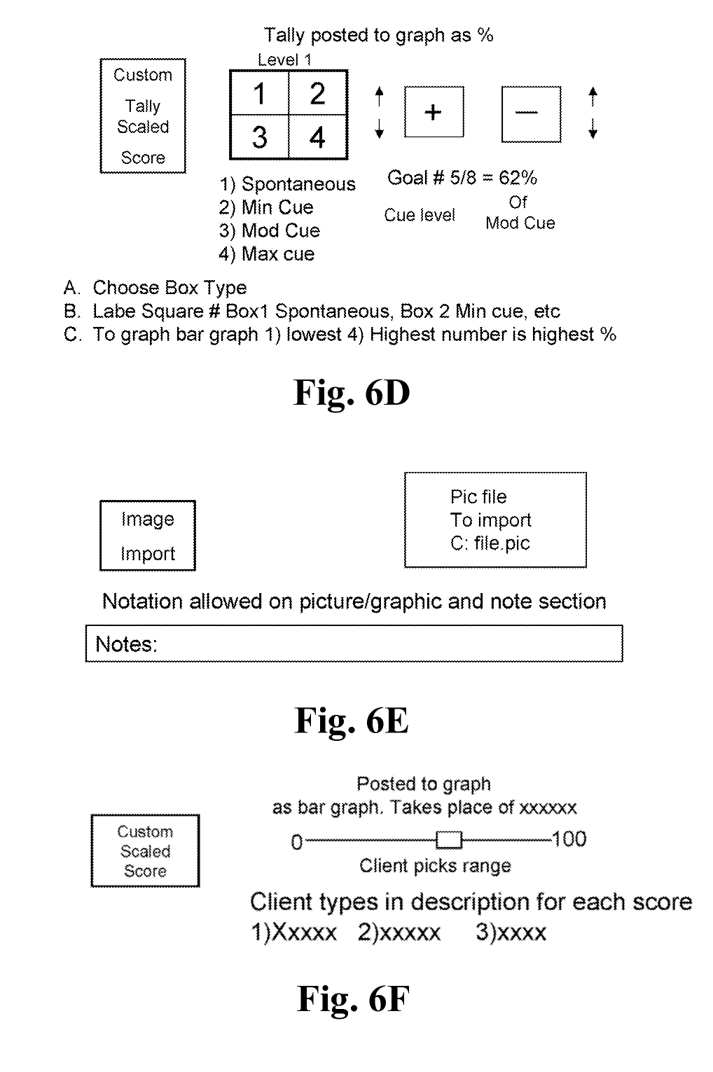

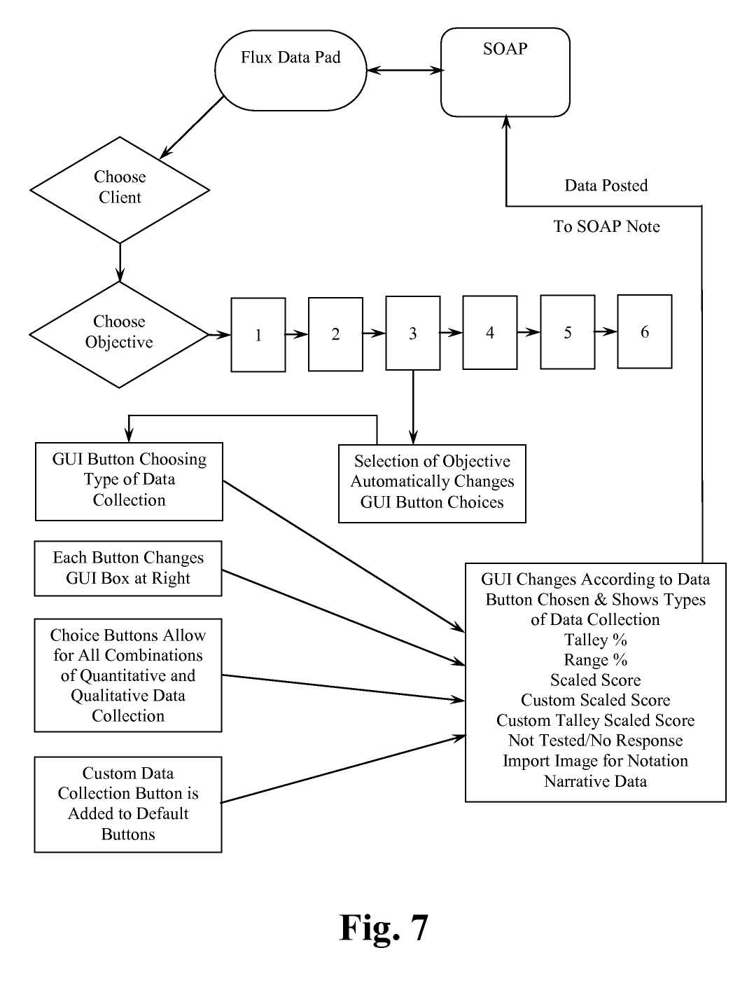

As stated earlier, this program, systems and methods allows for all separate pages to fill and populate the S.O.A.P. note while simplifying the use of each page by actual function. (FIG. 4A-C) is the “Flux Data Pad” that enables the clinician to collect all data instantaneously and populate the data portion of the S.O.A.P. note. The “G.U.I., or graphical user interface” on the “Flux Data Pad” allows for the use of seven different customizable button options for data collection. (FIG. 5) is a description of the “Flux Data Pad” G.D.I. where each button has a unique graphical input that allows instantaneous qualitative, quantitative and mixed combinations of data. The G.U.I. also allows for instantaneously jumping back and forth between clients, goals, objectives, type of data, variables, narrative data, and graphed progress records. FIG. 6A shows the data G.U.I. button for “Scaled Score”. FIG. 6B shows the G.U.I. button for the “Tally Scaled Score” data collection. FIG. 6C shows the G.U.I. button for the “% Range” score data collection and the G.U.I. button for “NT and NR” (not tested and no response). FIG. 6D shows the G.U.I. button for the “Custom Tally Scaled Score”. FIG. 6E shows the G.U.I. for “Image Import”; and FIG. 6F the G.U.I. for “Custom Scaled Score”. (FIG. 7) is a diagram that explains the flow and use of the “Flux Data Pad”

FIG. 4, 5 and FIGS. 6A-6F show screens that are always available to the therapist and fill the S.O.A.P. note. The FIGS. 4 and 5 screens may be closed but their information is automatically posted to and opens the S.O.A.P. note which must be completed, electronically signed and sent to the permanent file.

FIG. 5 allows the clinician to collect data in a spontaneous none planned client encounter using the systems and program's “G.U.I.” and format. If this data applies to client specific encounters it may be saved and attached to other files.

All information collected by the program is automatically posted to the “Research Library Database”. This information can then be sorted and analyzed for efficacy by the clinician.

FIG. 8 is a schematic diagram for information flow for “RESEARCH INTERVENTION PLAN” that collects and manipulates data in the method of the present invention.

I claim:

1. A method for recording, analyzing, storing, and reporting data and information on a portable computer system in association with a patient—therapist encounter, the method comprising the steps of:
(a) presenting a variable, selectable, graphic user interface (GUI) screen in the form of a consistently structured data pad for the capture of qualitative and quantitative data regarding the patient-therapist encounter;
(b) the therapist selecting a first GUI screen for a first set of data capture;
(c) automatically structuring user input buttons and fields on the GUI screen to facilitate the capture of the first set of data;
(d) recording the first set of data captured on the first GUI screen;
(e) repeating steps (a) through (d) for second and subsequent sets of data; and
(f) reporting on pre-structured forms the captured sets of data.
